(19) United States
(12) Patent Application Publication
(10) Pub. No.: US 2017/0369635 A1
(43) Pub. Date: Dec. 28, 2017

(54) RAPID-SET EPOXY RESIN SYSTEMS AND PROCESS OF COATING PIPELINES USING THE EPOXY RESIN SYSTEM

(71) Applicant: Dow Global Technologies LLC, Midland, MI (US)

(72) Inventors: Adam C. Colson, Lake Jackson, TX (US); Avery L. Watkins, Pearland, TX (US); Zubin B. Kuvadia, Pearland, TX (US); Kwanho Chang, Lake Jackson, TX (US)

(73) Assignee: Dow Global Technologies LLC, Midland, MI (US)

(21) Appl. No.: 15/533,640

(22) PCT Filed: Dec. 5, 2015
(86) PCT No.: PCT/US2015/064143

§ 371 Date: Jun. 6, 2017

Related U.S. Application Data
(60) Provisional application No. 62/096,814, filed on Dec. 24, 2014.

(51) Int. Cl. C08G 59/50; C08G 59/66

(52) U.S. Cl. CPC C08G 59/50; C08G 59/66

(57) ABSTRACT

Rapidly gelling epoxy resin systems include an epoxy resin, certain acrylate-functional compounds, and a curing agent mixture that includes a thiol curing agent and an amine curing agent. Gel times well less than 1 minute can be obtained. The ratio of acrylate-functional compound to thiol curing agent can be varied to adjust the gel time to precise values within a broad range.

This invention relates to an epoxy resin system and processes for using it, including a process for coating pipelines using the epoxy resin formulation.

Epoxy resin systems are used in a great variety of applications. As thermosets that are based on low molecular weight raw materials, they are useful in many cure-in-place applications where the uncured epoxy resin system is deposited where needed and then cured.

A limitation on epoxy resin systems is their reactivity. They do not cure rapidly enough to be used in certain applications. If deposited on a vertical side of a substrate or on the underside of a horizontal substrate, for example, the epoxy resin system tends to drip or run off before it cures enough to bear its own weight. This problem can be overcome to a limited extent through the use of elevated curing temperatures, but this approach is not amenable to a great number of applications, because curing still is too slow even with the applied heat, or because there is not a practical way to supply the necessary heat to effect the rapid cure.

Pipeline rehabilitation is an example of such an application. Water pipelines, for example, commonly are buried and remain underground for perhaps decades. During this time, the pipes corrode and decay, which causes them to leak and introduces corrosion by-products (such as rust particles) into the water. If originally lined, the lining can likewise degrade over time. Replacing the degraded pipelines requires that they be dug up and removed. In an urban environment especially, the cost of this is nearly prohibitive.

Therefore, it is desirable to rehabilitate these old pipelines by relining them in the field. One way of doing this is by spray-coating the internal surfaces of the pipeline with thermosetting resin composition, which then cures in place to form the new lining. Cured epoxy resins have very favorable characteristics that would make them very desirable for this application. However, their slow cure rates disqualify them because they run off of the top and vertical surfaces of the pipe before they gel.

Spray systems for pipeline rehabilitation instead are typically polyurea systems, which are based on the reaction of an isocyanate with an amine. The isocyanate-amine reaction is very fast, so those systems gel within seconds. Some hybrid systems have been developed that contain an epoxy resin, polyisocyanate and amine. The isocyanate-amine reaction provides rapid gelling that allows the system to develop enough physical strength to remain in place until the full cure of the epoxy resin occurs. Examples of epoxy and hybrid systems for rehabilitating pipelines are described, for example, in U.S. Pat. No. 5,216,170, U.S. Pat. No. 6,730,353, US 2004-0258836, US 2011-0070387, EP936235A, EP 2495271A, WO 2007/006656, WO 2010/120617, WO 2012/010528 and WO 2012/134662.

The polyurea and hybrid systems have some significant disadvantages. One is the use of isocyanate compounds, which raises potential issues of worker exposure and contamination of the water supply if insufficiently cured. A second is foaming. Isocyanate compounds react with water to generate carbon dioxide. It is difficult to avoid this reaction in the field, especially in pipe lining applications, as the water can come from, among other places, atmospheric moisture or residual water in the pipe. The liberated carbon dioxide forms bubbles that weaken the coating and can form defects at which leakage can occur. An alternative system that avoids these problems while retaining the good gelling profile of the polyurea and hybrid systems would be highly desirable.

EP 502611 describes epoxy resin systems that include an epoxy resin, acrylate compounds, thiol curing agents, and in some cases amine curing agents. The acrylate and thiol curing agents are polymeric materials having equivalent weights on the order of about 400 or greater, and the amine curing agent (Ancamine™ 1618) also has a somewhat high equivalent weight. Gel times as low as two minutes are reported in EP 502611, but only at very high levels of the acrylate compound.

This invention is in one aspect an epoxy resin system comprising an A-side and a B-side, the A-side including:
A-1) an epoxy resin having an average of 1.8 to 6 epoxy groups per molecule and an epoxy equivalent weight of 150 to 300;
A-2) 3 to 20 parts by weight, per 100 parts by weight of component A-1), of a polyacrylate having an average of 2 to 8 acrylate groups per molecule and an equivalent weight per acrylate group of 80 to 250; and
A-3) 0 to 10 parts by weight, per 100 parts by weight of component A-1), of a polymethacrylate having an average of 2 to 8 methacrylate groups per molecule and an equivalent weight per methacrylate group of 95 to 265;

and the B-side including:
B-1) an amine curing agent having an average of 2 to 8 amine hydrogens per molecule and an amine hydrogen equivalent weight of 15 to 100 and
B-2) a thiol curing agent having an average of 2 to 8 thiol groups per molecule and an equivalent weight per thiol group of 50 to 300;

wherein the proportions of the A-side and B-side are such that (i) the A-side contains 0.3 to 2 equivalents combined of acrylate and methacrylate groups per equivalent of thiol groups in the B-side and (ii) the B-side contains from 0.75 to 1.5 equivalents of thiol groups and amine hydrogens combined per combined equivalents of epoxy, acrylate and methacrylate groups in the A-side.

The invention is also a method of forming a cured thermoset polymer by combining the aforementioned A-side and B-side to form a reaction mixture and curing the reaction mixture to form the cured thermoset polymer. In some embodiments, the method is performed by applying the combined A- and B-sides to the internal surfaces of a pipe and curing the reaction mixture while in contact with the internal surfaces of the pipe to form a cured thermoset polymer coating on the internal surfaces of the pipe.

The invention is in another aspect method of forming a cured thermoset polymer comprising:

1. forming a reaction mixture by combining
A-1) an epoxy resin having an average of 1.8 to 6 epoxy groups per molecule and an epoxy equivalent weight of 150 to 300;
A-2) 3 to 20 parts by weight, per 100 parts by weight of component A-1), of a polyacrylate having an average of 2 to 8 acrylate groups per molecule and an equivalent weight per acrylate group of 80 to 250; and
A-3) 0 to 10 parts by weight, per 100 parts by weight of component A-1), of a polymethacrylate having an average of 2 to 8 methacrylate groups per molecule and an equivalent weight per methacrylate group of 95 to 265;
B-1) an amine curing agent having an average of 2 to 8 amine hydrogens per molecule and an amine hydrogen equivalent weight of 15 to 100 and
B-2) a thiol curing agent having an average of 2 to 8 thiol groups per molecule and an equivalent weight per thiol group of 50 to 300;

wherein the proportions of the ingredients A-1, A-2, A-3, B-1 and B-2 are such that (i) 0.3 to 2 equivalents combined of acrylate and methacrylate groups are provided to the reaction mixture per equivalent of thiol groups and (ii) 0.75 to 1.5 equivalents of thiol groups and amine hydrogens combined are provided to the reaction mixture per combined equivalents of epoxy, acrylate and methacrylate groups in the A-side; and

2. curing the reaction mixture to form the cured thermoset polymer.

The invention is in yet another aspect a method for lining the internal surface of a pipe with a cured thermoset resin, comprising:

1. forming a reaction mixture by combining
A-1) an epoxy resin having an average of 1.8 to 6 epoxy groups per molecule and an epoxy equivalent weight of 150 to 300;
A-2) 3 to 20 parts by weight, per 100 parts by weight of component A-1), of a polyacrylate having an average of 2 to 8 acrylate groups per molecule and an equivalent weight per acrylate group of 80 to 250; and
A-3) 0 to 10 parts by weight, per 100 parts by weight of component A-1), of a polymethacrylate having an average of 2 to 8 methacrylate groups per molecule and an equivalent weight per methacrylate group of 95 to 265;
B-1) an amine curing agent having an average of 2 to 8 amine hydrogens per molecule and an amine hydrogen equivalent weight of 15 to 100 and
B-2) a thiol curing agent having an average of 2 to 8 thiol groups per molecule and an equivalent weight per thiol group of 50 to 300;

wherein the proportions of the ingredients A-1, A-2, A-3, B-1 and B-2 are such that (i) 0.3 to 2 equivalents combined of acrylate and methacrylate groups are provided to the reaction mixture per equivalent of thiol groups and (ii) 0.75 to 1.5 equivalents of thiol groups and amine hydrogens combined are provided to the reaction mixture per combined equivalents of epoxy, acrylate and methacrylate groups in the A-side;

2. applying the reaction mixture to an internal surface of the pipe; and

3. curing the reaction mixture in contact with the internal surface of the pipe to form a coating of the cured thermoset polymer thereon.

This invention provides a rapidly-gelling epoxy resin system. Gel times are often on the order of 30 seconds or less, even when the reactants are combined at ambient temperature and cured without further applied heat. Although catalysts can be used if desired, in many embodiments short gelation times can be obtained even in the absence of catalysts.

Another surprising and beneficial aspect of the invention is that the gelation time is highly “tunable” through the manipulation of the ratios of the various components. Paramount among these is the ratio of acrylate to thiol groups. It has been found that gel times are very sensitive to this ratio and can be varied quite significantly through changes to it. The ratio of acrylate to methacylate groups also is a useful tool for varying gel time. The functionality of the thiol also has a large effect on gel times, as does the presence or absence of catalyst and the catalyst amount when used. By manipulating one or more of these parameters, close control of gel times can be achieved.

Similarly, the properties of the resulting polymer are easily varied to produce products having properties adapted to particular applications. One way of varying those properties is through adjustments in the proportions of the thiol and amine curing agents. Thus, a simple tool is provided by which polymer properties can be tuned within certain ranges to fit the needs of specific applications.

The epoxy resin is one or more epoxy group-containing compounds. The epoxy resin has an average of 1.8 to 6 epoxide groups per molecule, preferably 2 to 6 epoxide groups per molecule, and a number epoxy equivalent weight 150 to 300. The number average epoxy equivalent weight may be at least 170 and may be up to 250 or up to 225. The epoxy resin preferably has 2 to 4 epoxide groups per molecule.

The epoxy resin preferably is a liquid at room temperature, to facilitate easy mixing with other components. However, it is possible to use solid (at 25° C.) epoxy resin, particularly if the mixture of epoxy resin and polyacrylate compound form a liquid mixture at 25° C.

Among the useful epoxy resins include, for example, polyglycidyl ethers of polyphenolic compounds. One type of polyphenolic compound is a diphenol (i.e., a compound having exactly two aromatic hydroxyl groups) such as, for example, resorcinol, catechol, hydroquinone, biphenol, bisphenol A, bisphenol AP (1,1-bis(4-hydroxylphenyl)-1-phenyl ethane), bisphenol F, bisphenol K, tetramethylbiphenol, or mixtures of two or more thereof. The polyglycidyl ether of such a diphenol may be advanced, provided that the epoxy equivalent weight is as mentioned before.

Fatty acid-modified polyglycidyl ethers of polyphenols, such as D.E.R. 3680 from The Dow Chemical Company, are useful epoxy resins.

Other useful polyglycidyl ethers of polyphenols include epoxy novolac resins. The epoxy novolac resin can be generally described as a methylene-bridged polyphenol compound, in which some or all of the phenol groups are capped with epichlorohydrin to produce the corresponding glycidyl ether. The phenol rings may be unsubstituted, or may contain one or more substituent groups which, if present, are preferably alkyl having up to six carbon atoms and more preferably methyl.

Other useful polyglycidyl ethers of polyphenol compounds include, for example, tris(glycidyloxyphenyl)methane, tetrakis(glycidyloxyphenyl)ethane, and the like.

Still other useful epoxy resins include polyglycidyl ethers of aliphatic polyols. The aliphatic polyols may be, for example, alkylene glycols and polyalkylene glycols such as ethylene glycol, diethylene glycol, tripropylene glycol, 1,2-propane diol, dipropylene glycol, tripropylene glycol and the like as well as higher functionality polyols such as glycerin, trimethylolpropane, trimethylolethane, pentaerythritol, sorbitol and the like. These preferably are used together with an aromatic epoxy resin such as a diglycidyl ether of a biphenol or an epoxy novolac resin.

Still other useful epoxy resins include tetraglycidyl diaminodiphenylmethane; oxazolidone-containing compounds as described in U.S. Pat. No. 5,112,932; cycloaliphatic epoxides; and advanced epoxy-isocyanate copolymers such as those sold commercially as D.E.R.™ 592 and D.E.R.™ 6508 (The Dow Chemical Company) as well as those epoxy resins described, for example, in WO 2008/140906.

The polyacrylate is one or more compounds containing acrylate (—O—C(O)—CH═CH₂) groups. The polyacrylate contains an average of 2 to 8 acrylate groups per molecule, and preferably contains 2 to 6, 2 to 4 or 2 to 3 acrylate groups per molecule. The equivalent weight per acrylate group of the polyacrylate is 80 to 250, and may be 80 to 200, 90 to 200, 100 to 175 or 100 to 150. The polyacrylate compound(s) in some embodiments are as represented by the structure:

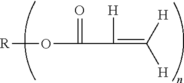

wherein R is an organic linking group and n represents the number of acrylate groups as described before. R may be, for example, a hydrocarbon such as linear alkyl, branched alkyl or cycloaliphatic alkyl (or a combination thereof), any of which may be inertly substituted. In inert substituent is one which does not engage in a reaction (under the curing conditions) with the epoxy resin or curing agents such as, for example, an aromatic group, an alkyl aromatic group, halogen, oxygen, nitrogen, silicon, phosphorus, sulfur and the like. R may contain one or more hydroxyl groups, but preferably does not contain any other groups (other than the acrylate groups and any hydroxyl groups as may be present) that are reactive with acrylate or epoxy groups, or with thiol groups or amine nitrogen. The mass of the R group is such that the polyacrylate compound has an equivalent weight as described before.

R is preferably linear or branched alkyl, an alkyl ether or a polyether group. R may be, for example, a linear or branched alkylene group or a linear or branched alkylene ether or polyether group, in each case having 2 to 10, preferably 2 to 8 carbon atoms. R may correspond to the residue, after removal of hydroxyl groups, of a polyol compound such as ethylene glycol, diethylene glycol, triethylene glycol, tetraethylene glycol, 1,2-propane diol, 1,3-propane diol, dipropylene glycol, tripropylene glycol, 1,4-butanediol, 1,6-hexanediol, 1,8-octanediol, glycerin, trimethylolethane, trimethylolpropane, triethanolamine, triisopropanolamine, erythritol, pentaerythritol, dipentaerythritol, sucrose, sorbitol, mannitol, a low molecular weight poly(vinyl alcohol) oligomer, a low molecular weight poly(hydroxyethylacrylate) oligomer and the like. The polyacrylate compound can be prepared, for example, by the reaction of acrylic acid or an acrylic acid halide with a polyol such as any of the polyol compounds just mentioned, to convert some or all of the hydroxyl groups to acrylate groups.

The amount of the polyacrylate is from 3 to 20 parts per weight per 100 parts by weight of the epoxy resin. At smaller amounts, the gel times tend to be too long. At higher amounts, gel times can become so short that the formulation becomes difficult to process, and substantial losses in glass transition temperature and certain physical properties are often seen. At amounts from 3 to 20 parts per 100 parts of epoxy resin, the properties of the cured thermoset of the invention tend to closely resemble those of the cured epoxy resin by itself. The system may be provided with 5 to 15, 7 to 15, 8 to 13 or 8 to 12 parts by weight of the polyacrylate compound(s) per 100 parts by weight epoxy resin(s).

The system may also be provided with up to 10 parts by weight, per 100 parts by weight of component A-1), of a polymethacrylate. Such a polymethacrylate is a methacrylate group-containing compound or mixture of such compounds, having an average of 2 to 8 methacrylate (—O—C(O)—C(CH₃)═CH₂) groups per molecule and a number average equivalent weight per methacrylate group of 95 to 265. The polymethacrylate compound can be as represented by the structure:

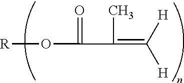

wherein R is as defined before with respect to the polyacrylate compound. The polymethacrylate compound can be made by reacting a polyol, including those described above with regard to the polyacrylate compound, with methacrylic acid or a methacrylic acid halide to replace two or more of the hydroxyl groups with methacrylate groups.

The polymethacrylate compound, if used, is used in small quantities. The methacrylate groups tend to react more slowly with thiol compounds than do the acrylates; therefore, replacing a portion of the polyacrylate compound with the polymethacrylate compound tends to increase the gel time. If present in greater amounts than 10 parts per 100 parts by weight epoxy resin, the gel time tends to be increased excessively. If present at all, it is preferred to use no more than 5 parts per 100 parts by weight of the epoxy resin(s) and to use no more than 0.5 parts, preferably no more than 0.35 part or no more than 0.25 part, per part by weight of polyacrylate compound.

The reaction mixture further contains a polythiol curing agent. The polythiol curing agent is a compound or mixture of compounds having thiol (mercaptan) groups. The polythiol curing agent has an average of 2 to 8 thiol groups per molecule. In some embodiments, the polythiol curing agent has a thiol functionality toward the high end of this range, such as an average of 3.5 to 8 thiol groups per molecule. In other embodiment, the average thiol functionality may be 2 to 6, 2 to 4 or 2 to 3 thiol groups per molecule. The polythiol curing agent has a number average equivalent weight per thiol group of 50 to 300. When the equivalent weight is 150 or greater, the polythiol curing agent preferably has an average of at least 3.5 thiol groups per molecule. The number average equivalent weight of the polythiol curing agent may be 50 to 250, 50 to 200, 65 to 200, or 65 to 150.

Examples of suitable polythiol compounds include alkylene dithiols such as 1,2-ethane dithiol, 1,2-propane dithiol, 1,3-propanedithiol, 1,4-butanedithiol, 1,6-hexanedithiol and the like, trithiols such as 1,2,3-trimercaptopropane, 1,2,3-tri(mecaptomethyl)propane, 1,2,3-tri(mercaptoethyl)ethane, (2,3-di((2-mercaptoethyl)thio)1-propanethiol, and the like. Also suitable are mercaptoacetate and mercaptopropionate esters of low molecular weight polyols having 2 to 8, preferably 2 to 4 hydroxyl groups and an equivalent weight of up to about 75, in which all of the hydroxyl groups are esterified with the mercaptoacetate and/or mercaptopropionate.

A polythiol curing agent having a higher functionality (such as from 3.5 to 8 or 3.5 to 6) can be prepared by coupling a polythiol compound having 3 or 4 thiol groups with a coupling agent. The coupling agent has two or more groups that react with a thiol group to form a bond to the thiol sulfur atoms. Enough of the coupling agent is reacted to consume approximately one thiol group per molecule of starting polythiol compound. An example of a suitable coupling agent is an epoxy resin, such as those described before. The epoxy resin used for this purpose preferably has 2 to 3, especially about 2, epoxy groups per molecule. In general, about 0.8 to 1.2 moles of starting polythiol compound is reacted per equivalent of thiol-reactive groups on the coupling agent to produce the coupled polythiol curing agent. The coupled polythiol curing agent may have an equivalent weight of, for example, 125 to 300, especially 150 to 225.

The amount of polythiol curing agent is such that 0.3 to 2 equivalents of acrylate and methacrylate groups combined are provided to the system per equivalent of thiol groups. It has been found that the gel time of these systems is highly dependent on this ratio and to some extent on the functionality of the polythiol compounds. Gel times tend to become quite short when the polythiol curing agent and polyacrylate/polymethacrylate compounds are provided in close to stoichiometric ratios. If the amount of polythiol curing agent departs from stoichiometry, the gel time increases dramatically. When the ratio of acrylate/methacrylate equivalents to thiol equivalents is below 0.3 equivalents or above 2, long gel times are achieved. When the polythiol compound(s) average functionality is lower (such as 2 to 3.4), short gel times are favored when the ratio of acrylate/methacrylate equivalents to thiol equivalents is 0.7 to 1.4, especially 0.8 to 1.25. Outside of these ranges, gel times increase dramatically. When the polythiol compound has a higher average functionality, such as 3.5 to 8 or 3.5 to 6, the equivalent ratio that provides short gel times is somewhat broader, such as 0.3 to 2.0, 0.4 to 1.4 or 0.45 to 1.25.

The reaction mixture further contains an amine curing agent. The amine curing agent is one or more compounds that contains at least one primary amino group, and/or at least two secondary amino groups. The amine curing agent has an average of 2 to 8 amine hydrogens per molecule and a number average amine hydrogen equivalent weight of 15 to 100. The amine compound may be, for example, an aliphatic amine, an aromatic amine or an aminoalcohol.

In the case of an aliphatic amine, the amine hydrogens each may be attached to (a) a nitrogen atom bonded directly to an acyclic aliphatic carbon atom, (b) a nitrogen atom bonded directly to a carbon atom that forms part of a cycloaliphatic ring (which ring may be heterocyclic) and/or (c) a nitrogen atom that itself forms part of an aliphatic cyclic structure. Among the suitable curing agents include, for example, aminocyclohexanealkylamines, i.e., cyclohexanes that have an amino substituent and an aminoalkyl substituent on the cyclohexane ring. Examples of such aminocyclohexanealkylamines include cyclohexanemethanamine, 1,8-diamino-p-menthane and 5-amino-1,3,3-trimethylcyclohexanemethylamine (isophorone diamine). Other useful amine curing agents include linear or branched polyalkylene polyamines such as, for example, diethylene triamine, triethylene diamine, tetraethylenepentamine, higher polyethylene polyamines, N′,N′-bis(2-aminoethyl)ethane-1,2-diamine, 2-methylpentane-1,5-diamine and the like. Still other amine curing agents include gem-di-(cyclohexanylamino)-substituted alkanes, diaminocyclohexane, aminoethylpiperazine and bis((2-piperazine-1-yl)ethyl)amine.

Suitable aromatic amines include, for example, aniline, toluene diamine, diphenylmethanediamine, diethyltoluenediamine and the like.

Suitable aminoalcohols include, for example, ethanolamine, diethanolamine, 1-amino-2-propanol, diisopropanolamine, and the like.

Enough of the amine curing agent is used to provide the system with 0.75 to 1.5, preferably 0.85 to 1.25, and more preferably 0.9 to 1.2, equivalents of thiol groups and amine hydrogens combined per combined equivalent of epoxy, acrylate and methacrylate groups.

A catalyst is not strictly necessary with this invention, as very short gel times can be obtained in many cases even when no catalyst is present. However, if particularly short gel times are desired, or the stoichiometry between thiol and acrylate/methacrylate groups is outside of certain ranges (as described above), a catalyst may be provided to shorten the gel time even more. In addition, although the initial gel can occur very rapidly, a full cure typically takes much longer. It may be desirable to provide a catalyst to shorten the time to full cure.

Suitable catalysts catalyze the reaction of thiol groups with acrylate or methacrylate groups and/or the reaction of amine hydrogens with epoxide groups. Many catalysts perform both functions.

The reaction mixture in some embodiments contains at least one basic catalyst. For purposes of this invention, a basic catalyst is a compound that is capable of directly or indirectly extracting a hydrogen from a thiol group to form a thiolate anion. In some embodiments, the basic catalyst does not contain thiol groups and/or amine hydrogens. The catalyst preferably is a material having a pKa of at least 5, preferably at least 10. These catalysts are often good catalysts for the epoxy-amine curing reaction.

Among useful types of catalysts include inorganic compounds such as salts of a strong base and a weak acid, of which potassium carbonate and potassium carboxylates are examples, various amine compounds, and various phosphines.

Suitable amine catalysts include various tertiary amine compounds, cyclic or bicyclic amidine compounds such as 1,8-diazabicyclo-5.4.0-undecene-7, tertiary aminophenol compounds, benzyl tertiary amine compounds, imidazole compounds, or mixtures of any two or more thereof.

Tertiaryaminophenol compounds contain one or more phenolic groups and one or more tertiary amino groups. Examples of tertiary aminophenol compounds include mono-, bis- and tris(dimethylaminomethyl)phenol, as well as mixtures of two or more of these. Benzyl tertiary amine compounds are compounds having a tertiary nitrogen atom, in which at least one of the substituents on the tertiary nitrogen atom is a benzyl or substituted benzyl group. An example of a useful benzyl tertiary amine compound is N,N-dimethyl benzylamine.

Imidazole compounds contain one or more imidazole groups. Examples of imidazole compounds include, for example, imidazole, 2-methylimidazole, 2-ethyl-4-methylimidazole, 2-undecylimidazole, 2-heptadecylimidazole, 2-phenylimidazole, 2-phenyl-4-methylimidazole, 1-benzyl-2-methylimidazole, 2-ethylimidazole, 2-isopropylimidazole, 2-phenyl-4-benzylimidazole, 1-cyanoethyl-2-undecylimidazole, 1-cyanoethyl-2-ethyl-4-methylimidazole, 1-cyanoethyl-2-undecylimidazole, 1-cyanoethyl-2-isopropylimidazole, 1-cyanoethyl-2-phenylimidazole, 2,4-diamino-6-[2′-methylimidazolyl-(1)′]ethyl-s-triazine, 2,4-diamino-6-[2′-ethylimidazolyl-(1)′]ethyl-s-triazine, 2,4-diamino-6-[2′-undecylimidazolyl-(1)′]ethyl-s-triazine, 2-methylimidazolium-isocyanuric acid adduct, 2-phenylimidazolium-isocyanuric acid adduct, 1-aminoethyl-2-methylimidazole, 2-phenyl-4,5-dihydroxylmethylimidazole, 2-phenyl-4-methyl-5-hydroxymethylimidazole, 2-phenyl-4-benzyl-5-hydroxymethylimidazole, and compounds containing two or more imidazole rings obtained by dehydrating any of the foregoing imidazole compounds or condensing them with formaldehyde.

Other useful catalysts include phosphine compounds, i.e., compounds having the general formula R³₃P, wherein each R³ is hydrocarbyl or inertly substituted hydrocarbyl, an inert substituent being one that does not react under the conditions of the curing reaction. Dimethylphenyl phosphine, trimethyl phosphine, triethylphosphine and the like are examples of such phosphine catalysts.

The basic catalyst, if used at all, is present in a catalytically effective amount. A suitable amount is typically from about 0.01 to about 10 moles of catalyst per equivalent of thiol and amine hydrogens in the curing agent. A preferred amount of catalyst (if any) is 0.1 to 1 mole of catalyst per equivalent of thiol and amine hydrogens in the curing agent. In some embodiments, no such catalyst is present.

In addition to the foregoing ingredients, the reaction mixture may contain various other materials. Such additional materials may include, for example, one or more colorants, one or more solvents or reactive diluents, one or more antioxidants, one or more preservatives, one or more fibers, one or more non-fibrous particulate fillers (including micron- and nano-particles), wetting agents and the like.

The reaction mixture preferably is substantially free of isocyanate compounds. Such compounds, if present at all, preferably constitute at most 1%, more preferably at most 0.5% of the weight of the reaction mixture. Most preferably the reaction mixture contains no measurable amount of isocyanate compounds.

The curing step can be performed in several ways.

In the simplest method, the starting materials are simply combined at ambient temperature (such as 15 to 40° C., especially 15 to 35° C.) and allowed to react. Higher or lower mixing temperatures can be used if desired. The reactants typically will react and cure spontaneously upon being combined, at least to the point of gelling. Full cure often can be achieved with applying heat; however, it may be desired to heat the reactants after combining them to promote the cure. If an elevated temperature cure is used, a suitable curing temperature is up to 180° C., especially 40 to 120° C. or 50 to 100° C.

It is generally beneficial to combine the polyacrylate and polymethacrylate (if any) with the epoxy resin prior to combining them with the curing agent(s). The polythiol and amine curing agents may be mixed and combined with the epoxy and polyacrylate/methacrylate compounds as a mixture. Alternatively, the thiol and amine curing agents may be added separately, provided that in such a case, the thiol curing agent is combined with the other ingredients simultaneously or after the amine curing agent(s).

It is often convenient to formulate the starting materials into a two-component system. The first component contains the polyacrylate, polymethacrylate (if any) and epoxy resin and the second component includes the curing agents. It is generally preferred to formulate any catalyst into one or both of the curing agents, but it can be added as a separate ingredient. Other ingredients can be formulated into either or both of the components, provided such compounds do not undesirably react therewith.

After the ingredients are combined, the reaction mixture can be dispensed onto a substrate and/or introduced into a mold or other container where the cure is to take place. Gelling takes place rapidly and spontaneously in most cases, without heating. After gelation, complete curing may require a prolonged period at close to room temperature, as the epoxy curing reaction is often relatively slow. The epoxy curing reaction can be accelerated by applying energy by, for example, heating and/or exposure to infrared energy.

In certain embodiments, the reaction mixture is applied to an internal surface of a pipeline and cured in contact with the internal surface to form a coating or lining of the cured thermoset polymer. The pipe may be buried or otherwise disposed in its place of use; for example, the pipe may form all or part of a water supply system, including a municipal drinking water supply system, an oil or natural gas pipeline, or other liquid transport system. The reaction mixture may be applied via a centrifugal spray head that moves through the pipe and as it moves dispenses the reaction mixture onto the surrounding internal pipe surfaces. Typically, the A-side and B-side components are formulated separately and separately pumped to the centrifugal spray head or a mixing device connected thereto, where they are combined in the proper ratios and dispensed.

The short gel times attainable with this invention represent a very significant advantage. Because the gel times are short, the applied reaction mixture in a matter of minutes or even seconds attains a sufficient degree of cure that is substantially retains its shape and can bear its own weight against the force of gravity. Adhesion to all internal surfaces of the pipe is normally quite good, and there is little dripping or run-off as the reaction mixture cures to form the coating. For these reasons, a good quality, highly uniform coating is obtained. The coating covers defects and blocks leakage sites, thus allowing an existing pipeline to be repaired or rehabilitated.

For purposes of this invention, gel times are measured as follows: The epoxy resin(s), polyacrylate compound(s) and polymethacrylate compound(s) (if any) are formulated into an A-side. The polythiol compound(s) and amine curing agent(s) are formulated into a B-side mixture. Other ingredients are introduced into the A- or B-side as appropriate. The A- and B-sides are then combined at room temperature by mixing at high speed for 20 seconds on a high-speed mixer. Time is measured from the time of mixing the A- and B-sides. After 20 seconds, the reaction mixture is cast onto a horizontal plate. If the reaction mixture has already solidified before the 20 seconds of mixing is completed, gel time is reported as ≦20 seconds. If the reaction mixture is still a liquid when cast onto the horizontal plate, its surface is then continuously tapped with a wood stick. The gel time is the elapsed time from the time the A- and B-sides are first mixed until strings no longer form when the stick is pulled away. Gelation is defined as an amount of cure such that the material no longer forms strings on this test. Gel times are often less than one minute or even less than 40 seconds, but as mentioned before, the gel time can be adjusted to be longer or shorter by manipulating ratios of components.

The following examples are provided to illustrate the invention, but not limit the scope thereof. All parts and percentages are by weight unless otherwise indicated.

Epoxy Resin 1 is a liquid diglycidyl ether of bisphenol A having an epoxy equivalent weight of 176-183.

### EXAMPLE 1

An A-side mixture is prepared by charging 10 g (0.056 epoxy equivalents) of Epoxy Resin 1 and 1.11 g (0.01 acrylate equivalents) of 1,6-hexanediol diacrylate (HDODA) into a high-speed laboratory mixer, where they are mixed at high speed until thoroughly blended. Separately, a B-side is prepared by combining 0.85 g (0.01 thiol equivalents) of 2,3-bis[(2-mercaptoethyl)thio]-1-propanethiol (DMPT) with 2.39 g (0.056 amine hydrogen equivalents) of isophorone diamine (IPDI). The B-side is added to the laboratory mixer and is stirred at room temperature into the A-side mixture at high speed for one minute.

In the foregoing formulation, the equivalent ratio of acrylate groups to thiol groups is 1:1. To study the effect of the amount of thiol on gel time, Example 1 is duplicated several times, in each case changing the proportions of DMPT and IPDA in the B-side. The amount of DMPT is decreased or increased relative to the Example 1 formulation, in each case increasing the amount of IPDA a corresponding amount so the total amine plus thiol equivalents in the B-side remains constant.

Gel times for each of these formulations are measured as described above.

Results for the Example 1 series of experiments are as indicated in Table 1:

TABLE 1

| | Gel Time, s | | | | | |
|---|---|---|---|---|---|---|
| Example | 1A | 1B | 1C | 1D | 1E | 1F |
| Meq. Epoxy | 56 | 56 | 56 | 56 | 56 | 56 |
| Meq. Acrylate | 10 | 10 | 10 | 10 | 10 | 10 |
| Meq. DMPT | 20 | 16.7 | 13.3 | 11.1 | 10 | 8.7 |
| Meq. IPDA | 46 | 49.3 | 52.7 | 54.9 | 56 | 57.3 |
| Acrylate:DMPT | 0.5:1 | 0.6:1 | 0.75:1 | 0.9:1 | 1:1 | 1.15:1 |
| eq. ratio | | | | | | |
| DMPT:IPDA | 0.43 | 0.34 | 0.25 | 0.20 | 0.18 | 0.15 |
| eq. ratio | | | | | | |
| Eq.-% DMPT | 33% | 37.5% | 42.9% | 47.3% | 50% | 53.5% |
| in B-side | | | | | | |
| Gel time, s | >120 | >120 | 30 | 20 | 25 | 110 |

The data in Table 1 demonstrates a large and unexpected effect of the amount of thiol curing agent on gel time. As the data shows, gel time reduces drastically as the amount of thiol increases from 37.5% to 42.9% of the total equivalents of the B-side, and then increases equally dramatically as the amount of thiol increases from 50% to 53.5%, on the same basis. The same trend is seen when the amount of thiol is expressed in relation to the amount of acrylate; cure time drops sharply as the acrylate:DMPT ratio decreases from 0.34 to 0.25, and increases sharply as this ratio decreases further from 0.18 to 0.15.

Plaques are prepared by spraying the formulation of Example 1E into an open mold. The A- and B-sides are loaded into disposable cartridges of a Ratio-Pak HSS Spray Gun. This spray gun is a low-pressure air-assisted spraying device equipped with a spray nozzle assembly that includes a bell house type 48-element static mixer. 339 g of the A-side and 99 g of the B-side are dispensed into and through the spray nozzle and onto an open mold. Gel time from the time of dispensing is measured using a wood stick as before. After gel time is measured, the coated mold is cured for 3 hours at 100° C. and glass transition temperature is measured by DMA as before.

The sprayed formulation has a gel time of 30 seconds, which is almost unchanged from that of the cast formulation (25 seconds). The glass transition temperature also is essentially changed by spraying, being 107° C. versus 105° C. for the cast plaque.

### EXAMPLE 2

Example 2 is prepared and tested for gel time in the same manner as Example 1. The A-side mixture is the same as Example 1. The B-side mixture is 1.303 g (10 thiol equivalents) of trimethylolpropane tri(3-mercaptoproprionate) (TMPMP) and 1.334 g (56 amine hydrogen equivalents) of triethylenetetramine (TETA).

Example 2 is duplicated several times, in each case adjusting the ratio of TMPMP and TETA so the total amine plus thiol equivalents in the B-side remain constant.

Table 2 shows the corresponding data for the Example 2 series of experiments:

TABLE 2

| | Gel Time, s | | | | | | | | |
|---|---|---|---|---|---|---|---|---|---|
| Example | 2A | 2B | 2C | 2D | 2E | 2F | 2G | 2H | 2I |
| Meq. Epoxy | 56 | 56 | 56 | 56 | 56 | 56 | 56 | 56 | 56 |
| Meq. Acrylate | 10 | 10 | 10 | 10 | 10 | 10 | 10 | 10 | 10 |
| Meq. TMPMP | 20 | 16.7 | 14.2 | 13.3 | 10 | 8.3 | 7.1 | 6.7 | 6.3 |
| Meq. TETA | 46 | 49.3 | 51.8 | 52.7 | 56 | 57.3 | 58.9 | 59.9 | 60.3 |
| Acrylate:TMPMP | 0.5 | 0.6 | 0.7 | 0.75 | 1.0 | 1.2 | 1.4 | 1.5 | 1.6 |
| eq. ratio | | | | | | | | | |
| TMPMP:TETA | 0.43 | 0.34 | 0.27 | 0.25 | 0.18 | 0.14 | 0.12 | 0.11 | 0.10 |
| eq. ratio | | | | | | | | | |
| Eq.-% TMPMP | 30% | 25% | 21.5% | 20.1% | 15% | 12.6% | 10.7% | 10.1% | 9.5% |
| in B-side | | | | | | | | | |
| Gel time, s | ≧120 | ≧120 | 30 | 20 | 20 | 20 | 30 | ≧120 | ≧120 |

These results again show the variability of gel time with ratio of acrylate to thiol groups. The gel time reaches a minimum when this ratio falls within the range of 0.7:1 to 1.4:1. Outside of this range, gel time increases very rapidly.

### EXAMPLES 3-8

Example 3: An A-side mixture is prepared by charging 10 g (56 epoxy milliequivalents) of Epoxy Resin 1 and 1.11 g (10 acrylate milliequivalents) of HDODA into a high-speed laboratory mixer, where they are mixed at high speed until thoroughly blended. Separately, a B-side is prepared by combining 1.303 g (10 thiol milliequivalents) of TMPMP 2,3-bis[(2-mercaptoethyl)thio]-1-propanethiol (DMPT) with 2.39 g (56 amine hydrogen milliequivalents) of isophorone diamine. The B-side is added to the laboratory mixer and is stirred at room temperature into the A-side mixture at high speed for one minute. The resulting reaction mixture is dispensed into a vertical mold and cured at 80° C. for 16 hours to produce plaques for property testing. Tensile strength, elongation, tensile modulus and glass transition temperature are evaluated as before.

Example 4 is made the same way as Example 3, except the amount of HDODA is reduced to 1 g and 0.11 of trimethyolpropane trimethacrylate (TMPTMA) is added to the A-side. The weight ratio of HDODA to TMPTMA is about 9:1. The amount of thiol curing agent is adjusted slightly to maintain the same ratio of acrylate and methacrylate groups combined to thiol groups.

Examples 5-8 are made the same way as Example 4, further reducing the amount of HDODA and increasing the amount of TMPTMA to produce weight ratios of HDODA to TMPTMA of 8:2, 6:4, 4:6 and 2:8. The amount of thiol curing agent is again adjusted slightly in each case.

Gel times are measured for each of Examples 3 and 5-8. Results are as follows:

TABLE 3

| Ex. No. | HDODA/TMPTMA weight ratio | Gel time, seconds |
|---|---|---|
| 3 | HDODA only, no TMPTMA | <20 |
| 5 | 8:2 | <20 |
| 6 | 6:4 | About 240 |
| 7 | 4:6 | About 480 |
| 8 | 2:8 | >1500 |

These results indicate the effect of replacing acrylate groups with methacrylate groups. The equivalent weights of HDODA and TMPTMA are very similar, so the weight ratios closely approximately the mole ratios of acrylate and methacrylate groups. Replacing up to about 20% of the acrylate groups with methacrylate groups has little effect on gel time, but replacing a greater proportion leads to a large increase. These results indicate that varying the ratio of acrylate to methacrylate groups is a useful means to “tune” the gel time of the system to a desired value.

Physical properties and glass transition temperature are measured for Examples 3, 4 and 5, as follows. A portion of the reaction mixture is dispensed into a vertical mold and cured at 80° C. for 16 hours to produce plaques. Dog-bone samples are cut from the cured plaques and tensile strength, elongation and tensile modulus are evaluated according to ASTM D638. Shore D hardness is measured according to ASTM D 2240.

Glass transition temperature is measured by dynamic mechanical analysis. Rectangular bars 47.5 mm in length and 7 mm wide are cut from the plaques. Dynamic mechanical analysis (DMA) is performed in a torsion mode using a strain-controlled ARES rheometer. The temperature is ramped from −100° C. to 200° C. at a rate of 3° C./minute. Strain frequency is 1 Hz and strain amplitude is 0.05%.

Results are as in Table 4. For comparison, those of commercially available polyurea spray-in-place (SIP) and epoxy cure-in-place (CIP) systems are provided.

TABLE 4

| | Designation | | | | |
|---|---|---|---|---|---|
| | | | | Polyurea | Epoxy |
| Property | Ex. 3 | Ex. 4 | Ex. 5 | SIP | CIP |
| Tensile Str. (MPa) | 86 | 73 | 48 | 39 | 72 |
| Elongation, % | 4.5 | 6.8 | 14 | 5 | 5 |
| Tensile Modulus (MPa) | 3300 | 3300 | 2250 | N.D. | 3300 |
| Hardness (Shore D) | 87 | 85 | 83 | 87 | N.D. |
| T_{g} (° C.) | 105-110 | 105 | 102 | 96 | 85 |

Examples 3-5 have physical properties very comparable to the cure-in-place epoxy system, with a significantly higher glass transition temperature. Examples 4 and 5 show the effect of the increasing amount of TMPTMA at the expense of HDODA—the TMPTMA reduces tensile properties and increases elongation, each of which is consistent with a plasticization effect. The tensile strength of Examples 3-5 is generally superior to that of the polyurea spray-in-place formulation.

### EXAMPLES 9-11

1.27 mg of a 33% triethylene diamine catalyst solution is added dropwise to 80 g of Epoxy Resin 1 and mixed at high speed for 2 minutes. 150 g of DMPT is separately heated to 80° C. under nitrogen. 77.7 g of the epoxy resin/catalyst mixture is added to the heated DMPT and the resulting mixture is heated at 80° C. for six hours. The product is a coupled thiol-epoxy resin adduct having a calculated thiol equivalent weight of 176 g/mol and approximately 4 thiol groups per molecule. This is designated Thiol Adduct 1.

Thiol Adduct 2 is made in the same manner except only 62.2 g of the epoxy resin/catalyst mixture is added to the DMPT. The thiol-epoxy resin adduct (Thiol Adduct 2) has a calculated thiol equivalent weight of 154 g/mol and approximately 4 thiol groups per molecule.

Examples 9-11 are made in the same general manner as the earlier Examples. The formulations are as indicated in Table 5. TMPTA is trimethylolpropanetriacrylate.

TABLE 5

| | Parts By Weight (millequivalents) | | | |
|---|---|---|---|---|
| Ingredient | | Ex. 9 | Ex. 10 | Ex. 11 |

| | | | | | | |
|---|---|---|---|---|---|---|
| Epoxy Resin 1 | 10 | (56) | 10 | (56) | 10 | (56) |
| HDODA | 1.11 | (10) | 1.11 | (10) | 0 | (0) |
| TMPTA | 0 | (0) | 0 | (0) | 1.11 | (11) |
| Thiol Adduct 1 | 1.95 | (11) | 0 | (0) | 0 | (0) |
| Thiol Adduct 2 | 0 | (0) | 1.51 | (10) | 2.05 | (13) |
| IPDA | 2.334 | (54) | 2.39 | (56) | 2.23 | (53) |

| | | | |
|---|---|---|---|
| Equivalent Ratio, | 0.88 | 1.0 | 0.84 |
| acrylate:thiol | | | |

All of Examples 9-11 gel within 20 seconds on the foregoing test.

Each of Examples 9-11 is repeated several times, changing the proportions of DMPT and IPDA in the B-side. The amount of DMPT is decreased or increased relative to the Example 9, 10 or 11 formulation, in each case increasing the amount of IPDA a corresponding amount so the total amine plus thiol equivalents in the B-side remains constant. This has the effect of increasing or decreasing the acrylate/thiol equivalent ratio. When gel times are measured, it is seen that very fast gelation is obtained in across a wider range of acrylate/thiol equivalent weight ratios that is seen for Examples 1-3. For Example 9, gelation is ≦20 seconds across an acrylate/thiol ratio of about 0.5 to 1.2. For Example 10, gelation is ≦20 seconds across an acrylate/thiol ratio of about 0.56 to 1.20. And for Example 11, gelation is ≦20 seconds across an acrylate/thiol ratio of about 0.40 to well above 1.0.

### EXAMPLES 12-16

Examples 12-16 are made in the same general manner as the earlier Examples. The formulations are as indicated in Table 6.

TABLE 6

| | Parts By Weight (Milliequivalents) | | | | | | | | | |
|---|---|---|---|---|---|---|---|---|---|---|
| Ingredient | Ex. 12 | | Ex. 13 | | Ex. 14 | | Ex. 15 | | Ex. 16 | |
| Epoxy | 10 | (56) | 10 | (56) | 10 | (56) | 10 | (56) | 10 | (56) |
| Resin 1 | | | | | | | | | | |
| TMPTA | 1.1 | (11) | 0.7 | (7) | 0.6 | (6) | 0.5 | (5) | 0.4 | (4) |
| Thiol | 4.1 | (27) | 2.7 | (18) | 2 | (13) | 1.5 | (10) | 0.8 | (5) |
| Adduct 2 | | | | | | | | | | |
| IPDA | 1.7 | (40) | 2.0 | (46) | 2.1 | (49) | 2.2 | (51) | 2.4 | (56) |

| | | | | | |
|---|---|---|---|---|---|
| Equivalent | 0.42 | 0.40 | 0.46 | 0.52 | 0.78 |
| Ratio, | | | | | |
| acrylate:thiol | | | | | |

Example 16, with only 4 parts of acrylate compound per 100 parts epoxy resin, gels very slowly. However, by adding more Thiol Adduct 2 to the formulation to increase the acrylate:thiol equivalent ratio, a gel time of <20 seconds is easily achieved.

Examples 12-15, which have more of the acrylate compound exhibit gel times of <20 seconds despite the low acrylate:thiol equivalent ratios.

Example 12 is repeated, reducing the acrylate to thiol ratio to 0.337; no gelation occurs. By adding 15 mg of 1,8-diazabicyclo[5.4.0]undec-7-ene to that formulation, however, rapid gelation takes place despite the low acrylate to thiol ratio, accompanied by an exotherm to 140° C.

1. An epoxy resin system comprising an A-side and a B-side, the A-side including:
A-1) an epoxy resin having an average of 2 to 6 epoxy groups per molecule and an epoxy equivalent weight of 150 to 300;
A-2) 3 to 20 parts by weight, per 100 parts by weight of component A-1) of a polyacrylate having an average of 2 to 8 acrylate groups per molecule and an equivalent weight per acrylate group of 80 to 250; and
A-3) 0 to 10 parts by weight, per 100 parts by weight of component A-1) of a polymethacrylate having an average of 2 to 8 methacrylate groups per molecule and an equivalent weight per methacrylate group of 95 to 265;
and the B-side including:
B-1) an amine curing agent having an average of 2 to 8 amine hydrogens per molecule and an amine hydrogen equivalent weight of 15 to 100 and
B-2) a thiol curing agent having an average of 2 to 8 thiol groups per molecule and an equivalent weight per thiol group of 50 to 300;
wherein the proportions of the A-side and B-side are such that (i) the A-side contains 0.3 to 2 equivalents combined of acrylate and methacrylate groups per equivalent of thiol groups in the B-side and (ii) the B-side contains from 0.75 to 1.5 equivalents of thiol groups and amine hydrogens combined per combined equivalents of epoxy, acrylate and methacrylate groups in the A-side.

2. A method of forming a cured thermoset polymer comprising:
1. forming a reaction mixture by combining
A-1) an epoxy resin having an average of 2 to 6 epoxy groups per molecule and an epoxy equivalent weight of 150 to 300;
A-2) 3 to 20 parts by weight, per 100 parts by weight of component A-1) of a polyacrylate having an average of 2 to 8 acrylate groups per molecule and an equivalent weight per acrylate group of 80 to 250; and
A-3) 0 to 10 parts by weight, per 100 parts by weight of component A-1) of a polymethacrylate having an average of 2 to 8 methacrylate groups per molecule and an equivalent weight per methacrylate group of 95 to 265;
B-1) an amine curing agent having an average of 2 to 8 amine hydrogens per molecule and an amine hydrogen equivalent weight of 15 to 100 and
B-2) a thiol curing agent having an average of 2 to 8 thiol groups per molecule and an equivalent weight per thiol group of 50 to 300;
wherein the proportions of the ingredients A-1, A-2, A-3, B-1 and B-2 are such that (i) 0.3 to 2 equivalents combined of acrylate and methacrylate groups are provided to the reaction mixture per equivalent of thiol groups and (ii) 0.75 to 1.5 equivalents of thiol groups and amine hydrogens combined are provided to the reaction mixture per combined equivalents of epoxy, acrylate and methacrylate groups in the A-side; and
2. curing the reaction mixture to form the cured thermoset polymer.

3. A method for lining the internal surface of a pipe with a cured thermoset resin, comprising:
1. forming a reaction mixture by combining
A-1) an epoxy resin having an average of 2 to 6 epoxy groups per molecule and an epoxy equivalent weight of 150 to 300;
A-2) 3 to 20 parts by weight, per 100 parts by weight of component A-1) of a polyacrylate having an average of 2 to 8 acrylate groups per molecule and an equivalent weight per acrylate group of 80 to 250; and
A-3) 0 to 10 parts by weight, per 100 parts by weight of component A-1) of a polymethacrylate having an average of 2 to 8 methacrylate groups per molecule and an equivalent weight per methacrylate group of 95 to 265;
B-1) an amine curing agent having an average of 2 to 8 amine hydrogens per molecule and an amine hydrogen equivalent weight of 15 to 100 and
B-2) a thiol curing agent having an average of 2 to 8 thiol groups per molecule and an equivalent weight per thiol group of 50 to 300;
wherein the proportions of the ingredients A-1, A-2, A-3, B-1 and B-2 are such that (i) 0.3 to 2 equivalents combined of acrylate and methacrylate groups are provided to the reaction mixture per equivalent of thiol groups and (ii) 0.75 to 1.5 equivalents of thiol groups and amine hydrogens combined are provided to the reaction mixture per combined equivalents of epoxy, acrylate and methacrylate groups in the A-side;
2. applying the reaction mixture to an internal surface of the pipe; and
3. curing the reaction mixture in contact with the internal surface of the pipe to form a coating of the cured thermoset polymer thereon.

4. The process of claim 2 wherein step a) is performed at a temperature of 15 to 40° C. and step b) is performed without applying heat until at least the reaction mixture has gelled.

5. The process of claim 2 wherein the reaction mixture is cured at an elevated temperature after it has gelled.

6. The process of claim 2 wherein component A-2 has an equivalent weight of 100 to 175 and component B-2 has an equivalent weight of 65-200.

7. The process of claim 6 wherein component B-2 has an average of 3.5 to 8 thiol groups per molecule, and the proportions of the ingredients A-2, A-3 and B-2 are such that (i) 0.4 to 1.4 equivalents combined of acrylate and methacrylate groups are provided to the reaction mixture per equivalent of thiol groups.

8. The process of claim 7 wherein component B2 is a curing agent prepared by coupling a polythiol compound having 3 or 4 thiol groups with an epoxy resin having 2 to 3 epoxy groups per molecule.

9. The process of claim 6 wherein component B-2 has an average of 2 to 3.4 thiol groups per molecule, and the proportions of the ingredients A-2, A-3 and B-2 are such that (i) 0.8 to 1.25 equivalents combined of acrylate and methacrylate groups are provided to the reaction mixture per equivalent of thiol groups.

10. The process of claim 9 wherein component B-2 is one or more of 1,2-ethane dithiol, 1,2-propane dithiol, 1,3-propanedithiol, 1,4-butanedithiol, 1,6-hexanedithiol, 1,2,3-trimercaptopropane, 1,2,3-tri(mercaptomethyl)propane, 1,2,3-tri(mercaptoethyl)ethane, (2,3-di((2-mercaptoethyl)thio)1-propanethiol and a mercaptoacetate or mercaptopropionate esters of a low molecular weight polyols having 2 to 8 hydroxyl groups and an equivalent weight of up to about 75, in which ester all of the hydroxyl groups are esterified with the mercaptoacetate and/or mercaptopropionate.

11. The process of claim 9 wherein the reaction mixture is devoid of a basic catalyst.

12. The process of claim 2 wherein the reaction mixture contains at least one basic catalyst.
